(19) United States
(12) Patent Application Publication
(10) Pub. No.: US 2009/0089453 A1
(43) Pub. Date: Apr. 2, 2009

(54) REMOTE VISUALIZATION OF A GRAPHICS APPLICATION

(75) Inventors: Ronan Bohan, Wicklow (IE); John Hamill, Dublin (IE); Davide Pasetto, Dublin (IE)

Correspondence Address: IBM COPORATION (RTP);C/O SCHUBERT OSTERRIEDER & NICKELSON PLLC, 6013 CANNON MOUNTAIN DRIVE, S14, AUSTIN, TX, 78749, US

(73) Assignee: International Business Machines Corporation, Armonk, NY (US)

(21) Appl. No.: 12/208,098

(22) Filed: Sep. 10, 2008

(30) Foreign Application Priority Data
Sep. 27, 2007 (EP) 07117336.3

(51) Int. Cl. G06F 15/16

(52) U.S. Cl. 709/246

(57) ABSTRACT

Many embodiments provide a technique to allow the automatic conversion between the operating system specific interfaces of OpenGL based graphics applications. Embodiments comprise logic such as hardware and/or code related to the display of a graphics application using OpenGL functions executing on a local computer system and displayed on the screen or screens of one or more remote computer systems. The described embodiments may work regardless of the types of OS running on the local computer system and the remote computer system(s). In some embodiments, the OS-specific interface calls to OpenGL, in addition to the platform independent OpenGL calls, are translated into an OS-independent wire protocol. As a result, many embodiments provide automatic conversion between the OpenGL OS-specific interfaces at the local and remote computer systems.

### CROSS-REFERENCE TO RELATED APPLICATION

This application, in accordance with 35 USC §119, claims priority to and is a national stage application for European Patent Application No. 07117336.3, entitled “Method and System for Remote Visualization of a Graphics Application”, attorney docket number GB9-2007-0108-EP1, filed Sep. 27, 2007, the disclosure of which is incorporated herein in its entirety for all purposes.

### BACKGROUND

The present disclosure relates generally to the field of remote visualization of a graphics application. In particular, it relates to remote visualization of OpenGL (Open Graphics Library) based graphics applications across heterogeneous operating systems.

OpenGL is the standard cross-platform middleware Software Development Kit (SDK) for developing 3D applications. This SDK allows the application to access, in a multi-platform and multi-vendor environment, various 3D rendering primitives, and leverages any and all available hardware support and acceleration on the host system.

The OpenGL definition and syntax is operating system independent, thus a program that uses OpenGL may run on any operating system which supports it, once it has been compiled for that system.

On the other hand, the interface to the specific operating system (OS) is tailored to each individual OS and gives access to the OpenGL calls in the context of the windowing system in question. Several flavors of OS-specific interfaces exist, including:
GLX (OpenGL Extension to the X Window System), for Unix systems (Unix is a trade mark of The Open Group);
WGL (Windows Graphics Library), for Microsoft Windows systems (Microsoft and Windows are trade marks of Microsoft Corporation);
PGL for OS/2 WARP systems (OS/2 WARP is a trade mark of International Business Machines Corporation); and
AGL (Apple Graphics Library) and CGL (Core OpenGL) for Apple systems (Apple is a trade mark of Apple, Inc.).

These OS-specific interfaces, while necessary, are an impediment to making an OpenGL application cross-platform compatible.

Methods have been developed for an OpenGL application to be displayed on the screen of a remote workstation regardless of the OS running at each end. This is currently achieved by products which work in two different ways:
1. Rendering the image on the local hardware frame buffer, fetching and compressing the image pixels, and sending them to a remote viewer application for display only.
2. Encoding the OpenGL instruction stream into a wire protocol, sending the stream to the remote system, and decoding it back for execution with the local display driver, as if the OpenGL application was running natively. Compatibility between different operating systems is not currently possible using this method.

WireGL and Chromium (WireGL and Chromium are trade marks of Stanford University Computer Graphics Laboratory) are software products that allow the display of OpenGL applications on tiled wall displays. Both work by intercepting the OpenGL calls directed to the graphic card and transforming them into an encoded instruction stream which is sent over a network to the remote display for decoding and rendering.

WireGL is a UNIX only product, and encodes the GLX instruction stream in an operating system specific way. Chromium is available on UNIX and Windows but does not allow the interoperability between the two systems.

Wine (Wine is a trade mark of Microsoft Corporation) is a Microsoft Windows emulator for Linux (Linux is a trade mark of Linus Torvalds), which implements the WIN32 API and which gives access (to a certain extent) to machine accelerated OpenGL rendering. Wine allows Windows OpenGL applications to run under Linux by converting the application WGL calls into local GLX calls. However, no encoding/decoding or remote transmission of the application calls is performed.

### SUMMARY

According to one embodiment, there is provided a method for remote visualization of a graphics application, comprising: encoding operations of a first OpenGL interface for a first type of operating system as operating system independent operations; transmitting the operating system independent operations via a network connection; decoding the operating system independent operations into operations of a second OpenGL interface for a second type of operating system, wherein the first and second types of operating system may be different.

The operating system independent operations may be transmitted for rendering on a remote computer system. The operations may relate to windowing system specific rendering methods. The operations may be initialization and management methods for associating a drawable object with rendering contexts.

The method may also include transmitting drawing commands of an operating system independent form via the network.

The operating system independent operations may include operations for: the creation of contexts, the management of a current context, font handling, and extension handling.

The method may include executing an OpenGL based graphics application on a computer system with a first type of operating system; and intercepting operations from the graphics application for encoding. The method may further include rendering the decoded operations for display on one or more remote computer systems. The method may further include maintaining a map between context IDs of the graphics application and resultant context IDs on the one or more remote computer systems.

According to a second aspect of the present invention there is provided a system for remote visualization of a graphics application, comprising: an encoder for encoding operations of a first OpenGL interface for a first type of operating system as operating system independent operations; a wire protocol for transmitting the operating system independent operations via a network connection; a decoder for decoding the operating system independent operations into operations of a second OpenGL interface for a second type of operating system, wherein the first and second types of operating system may be different.

The wire protocol may also transmit drawing commands of an operating system independent form via the network.

According to a third aspect of the present invention there is provided a system for remote visualization of a graphics application, comprising: a local computer system with a first type of operating system; an OpenGL based graphics application executing on the local computer system; one or more remote computer systems for remote display of the graphics application, each with operating systems which may be of a different type from the first type of operating system; means for translating operating system specific OpenGL interface operations into and from operating system independent operations for transmitting between the local computer system and the one or more remote computer systems.

The means for translating operating system specific OpenGL interface operations into and from operating system independent operations may include: an encoder for encoding operations of a first OpenGL interface for a first type of operating system as operating system independent operations; and a decoder for decoding the operating system independent operations into operations of a second OpenGL interface for a second type of operating system, wherein the first and second types of operating system may be different.

According to a fourth aspect of the present invention there is provided a computer program product stored on a computer readable storage medium for remote visualization of a graphics application, comprising computer readable program code means for performing the steps of: encoding operations of a first OpenGL interface for a first type of operating system as operating system independent operations; transmitting the operating system independent operations via a network connection; decoding the operating system independent operations into operations of a second OpenGL interface for a second type of operating system, wherein the first and second types of operating system may be different.

Some embodiments may describe a technique for converting the OS-specific OpenGL interfaces into an OS-independent wire protocol, which can be transferred to a remote system and translated into appropriate calls for the OS-specific functions.

Some embodiments may integrate the remote OpenGL visualization technology with inter operating system compatibility support.

### BRIEF DESCRIPTION OF THE DRAWINGS

FIGS. 1A-B depicts block diagrams of embodiments of systems;

FIG. 2 depicts a block diagram of an embodiment of a computer system;

FIG. 3 illustrates a schematic representation of an embodiment of a system; and

FIG. 4 illustrates a flow chart of an embodiment for a method of encoding.

FIG. 5 illustrates a flow chart of an embodiment for a method of decoding.

### DETAILED DESCRIPTION OF EMBODIMENTS

The following is a detailed description of novel embodiments depicted in the accompanying drawings. However, the amount of detail offered is not intended to limit anticipated variations of the described embodiments; on the contrary, the claims and detailed description are to cover all modifications, equivalents, and alternatives falling within the spirit and scope of the present teachings as defined by the appended claims. The detailed descriptions below are designed to make such embodiments understandable to a person having ordinary skill in the art.

Generally, remote visualization of a graphics application are described herein. Many embodiments provide a technique to allow the automatic conversion between the operating system specific interfaces of OpenGL based graphics applications. Embodiments comprise logic such as hardware and/or code related to the display of a graphics application using OpenGL functions executing on a local computer system and displayed on the screen or screens of one or more remote computer systems. The described embodiments may work regardless of the types of OS running on the local computer system and the remote computer system(s).

In some embodiments, the OS-specific interface calls to OpenGL, in addition to the platform independent OpenGL calls, are translated into an OS-independent wire protocol. As a result, many embodiments provide automatic conversion between the OpenGL OS-specific interfaces at the local and remote computer systems.

While some of the specific embodiments described below will reference the embodiments with specific configurations, those of skill in the art will realize that embodiments of the present disclosure may advantageously be implemented with other configurations with similar issues or problems.

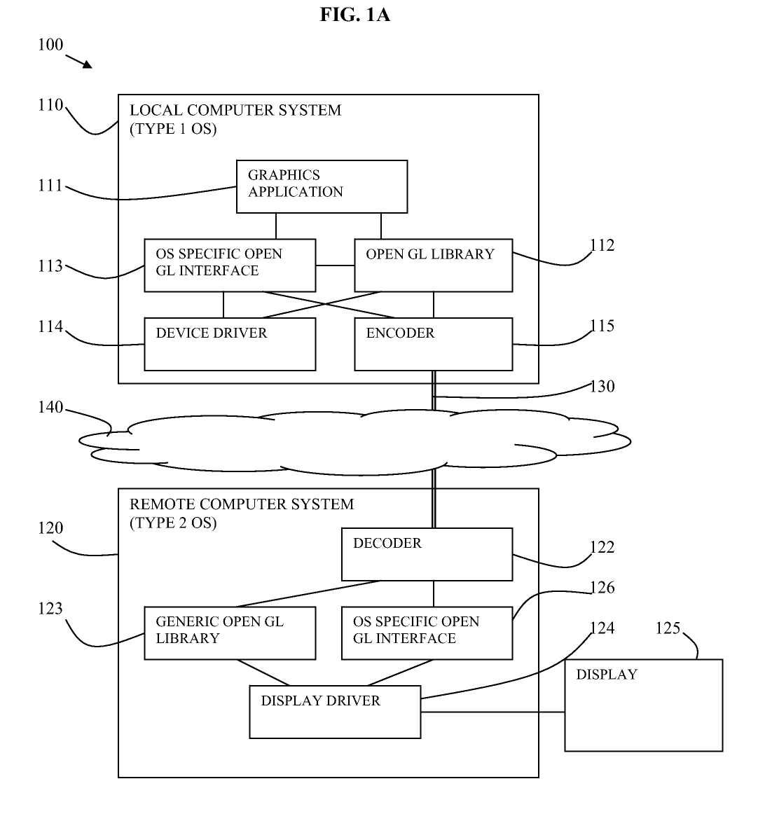

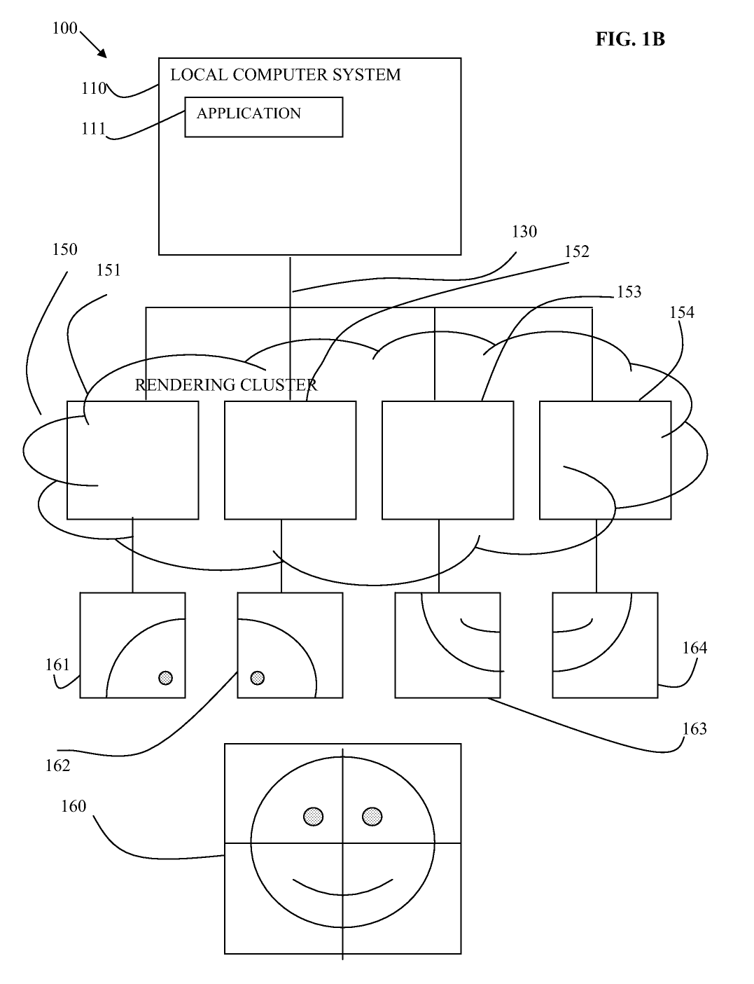

Referring to FIG. 1A, an embodiment comprising a computer system 100 is shown with a local computer system 110 running a first type of OS (OS Type 1) on which a graphics application 111 is executed. This may be referred to as the source computer system or source machine. The graphics application 111 is an OpenGL based graphics application which uses an OpenGL library 112.

The local computer system 110 runs an OS specific OpenGL interface 113 for the first type of OS (OS Type 1). For example, GLX for UNIX systems, WGL for Microsoft Windows systems, PGL for OS/2 Warp systems, and AGL for Apple systems.

A device driver 114 receives operations from the OpenGL library 112 and from the OS specific OpenGL interface 113 for local rendering. An encoder 115 also receives the same operations from the OpenGL library 112 and from the OS specific OpenGL interface 113 and translates these operations into an OS-independent wire protocol or data stream 130. Data stream 130 is then sent via a network 140 to one or more remote computer systems 120. These may also be referred to as target computer systems or target machines.

A single remote computer system 120 is shown in FIG. 1 which renders and displays the output of the graphics application 111. However, multiple remote computer systems 120 may display the output of the graphics application 111. Multiple remote computer systems 120 may be used to each display the entire output or a portion of the output, for example, in a tiled display.

The remote computer system 120 runs a second type of OS (OS Type 2) which may be different from the first type of OS (OS Type 1) of the local computer system 110.

The remote computer system 120 runs a generic OpenGL library 123 and an OS-specific OpenGL interface 126 for the second type of OS (OS Type 2). For example, one of GLX, WGL, PGL, or AGL.

The remote computer system 120 may consume the data stream 130 and a decoder 122 may convert the data stream 130 into the language required by the OS-specific OpenGL interface 126 and required by the local OpenGL library 123 of the remote computer system 120. A display driver 124 may then use the operations to display the output of the local graphics application 111 on a remote display 125

Referring to FIG. 1B, in one embodiment, the application 111 running on a local computer system 110 displays the output of the application 111 on a rendering cluster 150. The rendering cluster 150 is formed of a plurality of remote computer systems 151-154 which each render and display a portion 161-164 of a display 160. Each portion 161-164 may be of higher resolution than a single display on the local system 110.

In present embodiment, each remote computer system 151-154 of the rendering cluster 150 may use a different OS to the local computer system 110. An encoder may be used to translate the OS-specific context command operations of the application into generic operations which can be decoded at the individual remote computer system 151-154 into their OS-specific context commands.

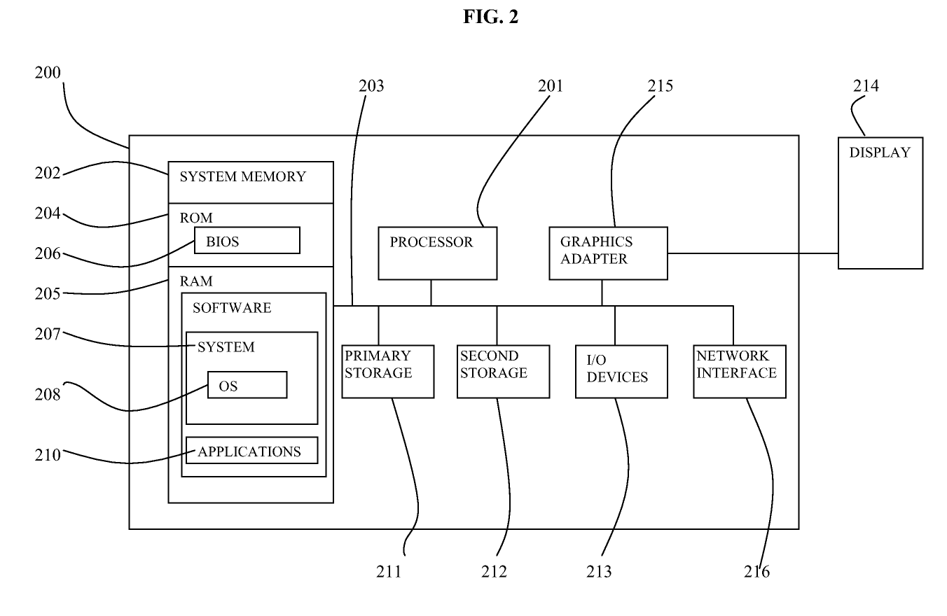

Referring to FIG. 2, an embodiment of a system for implementing the local and remote computer systems 110, 120 includes a data processing system 200 suitable for storing and/or executing program code including at least one processor 201 coupled directly or indirectly to memory elements through a bus system 203. The memory elements can include local memory employed during actual execution of the program code, bulk storage, and cache memories which provide temporary storage of at least some program code in order to reduce the number of times code must be retrieved from bulk storage during execution.

The memory elements may include system memory 202 in the form of read only memory (ROM) 204 and random access memory (RAM) 205. A basic input/output system (BIOS) 206 may be stored in ROM 204. System software 207 may be stored in RAM 205 including OS software 208. Software applications 210 may also be stored in RAM 205.

The system 200 may also include a primary storage means 211 such as a magnetic hard disk drive and secondary storage means 212 such as a magnetic disc drive and an optical disc drive. The drives and their associated computer-readable media may provide non-volatile storage of computer-executable instructions, data structures, program modules and other data for the system 200. Software applications may be stored on the primary and secondary storage means 211, 212 as well as the system memory 202.

The computing system 200 operates in a networked environment using logical connections to one or more remote computers via a network interface 216, sometimes referred to as a network adapter.

Input/output devices 213 can be coupled to the system either directly or through intervening I/O controllers. A user may enter commands and information into the system 200 through input devices such as a keyboard, pointing device, or other input devices (for example, microphone, joystick, game pad, satellite dish, scanner, or the like). Output devices may include speakers, printers, etc. A display device 214 is also connected to system bus 203 via an interface, such as a graphics adapter 215.

Several embodiments use hooking techniques which intercept the initialization, management and other OS-specific and Window-specific methods, referred to as meta-commands used by an OpenGL graphics application. In some embodiments, OpenGL applications may perform all operations inside drawable areas, for example in a window or in off-screen areas, such as pixmaps and/or p-buffers. The meta-commands may be used for associating a physical drawable object (provided by the OS) with a suitable 3D rendering of drawable and associated contexts (essentially implemented inside the hardware).

The meta-commands may be transmitted over a network to a target remote machine using the OS-independent wire protocol or data stream. This may allow the remote machine (or a group of machines working individually or together) to replicate a similar and compatible environment to that of the source machine, despite running different operating systems.

In such an environment, the actual drawing commands, which may be in an OS-independent format, can be encoded into the data stream, such that a set of machines can display the same graphical content (or a portion thereof, at higher resolution) as a source machine, without the need for any monitoring type function.

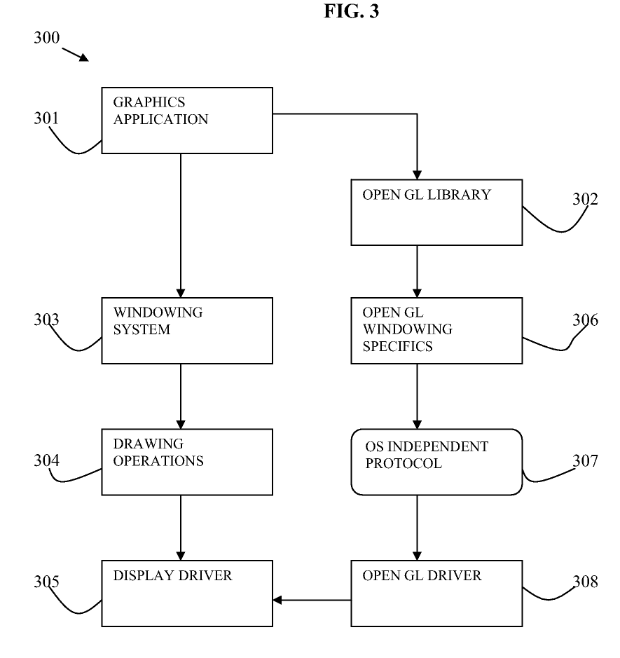

FIG. 3 provides a representation 300 of the layers of an embodiment of a system. A graphics application 301 may use an OpenGL library 302. The graphics application 301 may operate in a windowing system 303 and may perform 2D drawing operations 304 which can be passed to a display driver 305. The display driver 305 may be remote from the windowing system 303.

In the present embodiment, the OpenGL library 302 has OpenGL windowing specifics 306 required to display a graphic. The OpenGL windowing specifics 306 can be intercepted and translated into an OS-independent protocol 307 and transmitted to a remote OpenGL driver 308 that drives the remote display driver 305.

The operating system specific functionalities may be divided into four areas:

The Creation of Contexts

Management of the Current Context

Font Handling

OpenGL Extension Handling

These general areas apply across different platforms, but the implementation specifics can vary for each platform. By converting operating system specific operations into a platform and architecture agnostic wire protocol, cross-platform compatibility may be ensured. This can allow applications to run on one system, while performing their rendering on a completely different system, potentially featuring different rendering support. In a similar fashion, an application may be distributed among many rendering nodes to create a high definition tiled video wall display.

### The Creation of Contexts

OpenGL contexts may be used to set up an environment in which the OpenGL environment is specified and rendering operations are performed. To create a context, the user may specify the type of desired visual output, which includes the graphical pixel format, the types of buffers requested (e.g. Depth Buffers or Stencil Buffers) and other settings. Contexts may be copied or deleted.

Example functions for Unix (GLX) and Windows (WGL) are:

wglChoosePixelFormat—This queries the local system 110 to check if a specified pixel format is available on the local machine. There may be no need to encode or transmit this operation as its output is later used locally by wglCreateContext.

glXChooseVisual—This queries the local system for a specified visual (analogous to a PixelFormat in Windows). There may also be no need to encode this operation as its output is later used locally in glXCreateContext.

wglShareLists—This shares OpenGL “Display Lists” and other context information between separate contexts. There may be no need to perform a wire protocol operation, but the contexts with which to share are may be recorded for use by the wglCreateContext operation.

wglCreateContex—This can access the pixel format previously specified by wglChoosePixelFormat to retrieve visual information and to create an OpenGL context for rendering. This may be encoded in a CREATECONTEXT operation passing the device id (unique number) and the encoded visual information; to return a context ID to the application for future reference.

glXCreateContext—This can access the pixel information previously specified by glXChooseVisual to retrieve visual information and to create an OpenGL context for rendering. This may be encoded in a CREATECONTEXT operation passing the device id (unique number) and the encoded visual information; to return a context ID to the application for future reference.

By converting both these OS-specific operations into a single CREATECONTEXT operation in the wire protocol, the receiving system can decode the operation into its native format and carry out the operation. The wire protocol is OS-independent, allowing each system to handle the operation as appropriate to its architecture.

The CREATECONTEXT operation may include information on the graphical format previously requested by the client application using the appropriate “Choose” function (e.g. RGBA colour and the presence or absence of additional buffers such as a Stencil Buffer). As the context ID created on the encoding system is included in the CREATECONTEXT operation, the receiving systems may maintain a mapping to the true context ID created on the receiving system for future reference.

wglDeleteContext—This may be encoded in a DELETECONTEXT operation, passing the context ID.

glXDestroyContext—This may be encoded in a DELETECONTEXT operation, passing the context ID.

When the application wishes to destroy a rendering context it may call its appropriate OS-specific function. These functions can be converted to an OS-independent DELETECONTEXT operation and transmitted for appropriate handling by a receiving system.

wglCopyContext—This may be encoded in a COPYCONTEXT operation, passing the two context IDs and the mask.

glXCopyContext—This may be encoded in COPYCONTEXT operation, passing the two context IDs and the mask.

Similarly, a COPYCONTEXT wire protocol operation may be used to allow contexts to be copied both locally and remotely. Each platform may use the information encoded in the COPYCONTEXT operation to perform appropriate actions to complete the function.

### Management of Current Contexts

To use OpenGL instructions, the user may create a context, in an OS-specific way (e.g. glXCreateContext, wglCreateContext), and then bind this context (or make it current) to a drawing surface (e.g. Window Drawable or GDI Device Context) using another OS-specific call (e.g. glXMakeCurrent, wglMakeCurrent).

wglMakeCurrent—This may be encoded in a MAKECURRENT operation, passing the context ID and a surface ID, which is the Windows Device Context Handle ID.

glXMakeCurrent—This may be encoded in MAKECURRENT operation, passing the context ID and a surface ID, which is the X Windows Drawable ID for the current window.

wglGetCurrentContext—This may be encoded in a GETCURRENT operation, and may return context ID.

glXGetCurrentContext—This may be encoded in a GETCURRENT operation, and may return context ID.

glXGetCurrentDrawable—This may be encoded in a GETDRAW operation, and may return surface ID.

wglGetCurrentDC—This may be encoded in a GETDRAW operation, and may return surface ID.

A receiving system may decode the MAKECURRENT operation and may perform the appropriate OS-specific operations to complete the request. Similarly, a request for the currently active context may be translated into a GETCURRENT operation and retrieving the current Drawable or Device Context can become a GETDRAW operation.

As the mapping between the original client context IDs and the resultant context IDs on the receiving systems is maintained, these operations may be transparent to the original OpenGL application, but may operate seamlessly across different platforms.

wglSwapBuffers—This may be encoded in a SWAPBUFFERS operation.

glXSwapBuffers—This may be encoded in a SWAPBUFFERS operation.

A SWAPBUFFERS operation can be used to allow applications to signal that they wish to draw the rendered image on the display. In a double buffered environment, rendering may be performed off-screen and only swapped to the display when complete. This may prevent partially rendered images from being displayed. The wire protocol SWAPBUFFERS operation can allow this operation to occur across the rendering systems.

### Font Handling

In many embodiments, font handling may not be a part of the core OpenGL specification. Instead it can be provided for by various platform specific methods. On Microsoft Windows, for example, any system font may be used to create either a Bitmap font (stored as pixels) or an Outline font (stored as geometric shapes). On Unix systems, the option to create a Bitmap font may be readily available.

wglUseFontBitmaps—This may be encoded in a USEBITMAPFONT operation.

glXUseXFont—This may be encoded in a USEBITMAPFONT operation.

wglUseFontOutlines—There may be no need for a special operation. See below.

For the case of Bitmap fonts, the USEBITMAPFONT operation may allow the remote machine to select the most appropriate local font available to match the font used on the sending side. The geometric models created by a call to wglUseFontOutlines made by a Windows application may be sent via the wire protocol directly and rendered remotely, regardless of the remote system's platform. They may simply be rendered as would any other geometric model would be.

### OpenGL Extension Handling

Extensions may be a major part of OpenGL, allowing graphics vendors access to new rendering functionality without having to wait for the overall OpenGL specification to change. Typically, popular extensions may gain cross vendor support and may eventually be folded into the main OpenGL standard. The method of accessing OpenGL extensions can vary across different operating systems. A normal procedure may be to query the local OpenGL implementation (using glGetString(GL_EXTENSIONS)) to list its supported functionality and then request access to that functionality directly using the appropriate OS-specific function.

wglGetProcAddress—This may be encoded in a GETPROCADDRESS operation.

glXGetProcAddress—This may be encoded in a GETPROCADDRESS operation.

glGetString(GL_EXTENSIONS)—This may be encoded in a GETEXTENSIONS operation.

The GETPROCADDRESS wire protocol operation will provide the local system with access to its local functionality, while instructing the remote systems to use their native extension handling method. Where a difference exists in the capabilities of the local and remote system the GETEXTENSIONS operation can be used to provide appropriate information to the running application. For example, if rendering is being performed entirely on a remote system, the GETEXTENSIONS operation can indicate the hardware support present on that remote system instead of the local system (which may have fewer features).

There are more platform specific features than the ones detailed here that may also be translated into an appropriate OS-independent operation. The protocol entries listed here are a minimal set to allow cross-platform remote rendering to take place.

In summary, the following operating system independent commands described here may provide the following information.

Creation of Contexts:
CREATECONTEXT operation—passing device ID and encoded visual information, returns a context ID;
DELETECONTEXT operation—passing the context ID;
COPYCONTEXT operation—passing the two context IDs and the mask;

Management of Current Contexts:
MAKECURRENT operation—passing the context ID and a surface ID;
GETCURRENT operation—returns context ID;
GETDRAW operation—returns a surface ID;
SWAPBUFFERS operation;

Font Handling:
USEBITMAPFONT operation;

Extension Handling:
GETPROCADDRESS operation;
GETEXTENSIONS operation.

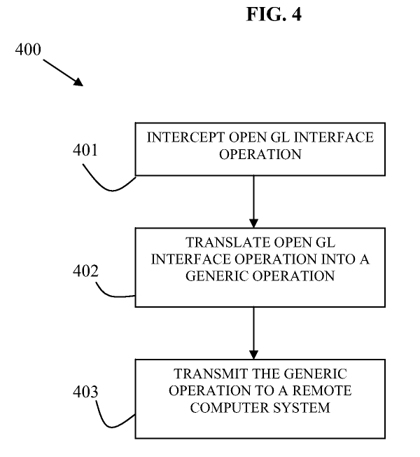

FIG. 4 shows a flow diagram 400 of a method of an embodiment applied at a local source computer system. An OpenGL interface operation may be intercepted 401 and translated 402 into a generic operation such as those discussed with respect to FIGS. 1-3. The generic operation can be transmitted over a network 403 to one or more remote computer systems.

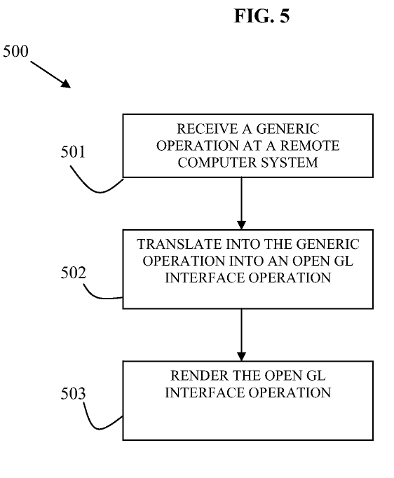

FIG. 5 shows a flow diagram 500 of a method of an embodiment applied at a remote target computer system. A generic operation may be received 501 at a remote computer system and translated 502 into the corresponding OpenGL interface operation suitable for the operating system of the remote computer system. The OpenGL interface operation may then be rendered at the remote computer system 503.

Embodiments outline a technique that allows for the interoperability of heterogeneous operating systems to provide remote visualization of OpenGL based applications. In one embodiment, this may be applied in large tiled display walls without any modifications to the application itself.

Embodiments can take the form of an entirely hardware embodiment, an entirely software embodiment or an embodiment containing both hardware and software elements. One embodiment is implemented in software, which includes but is not limited to firmware, resident software, microcode, etc.

Embodiments can take the form of a computer program product accessible from a computer-usable or computer-readable medium providing program code for use by or in connection with a computer or any instruction execution system. For the purposes of this description, a computer usable or computer readable medium can be any apparatus that can contain, store, communicate, propagate, or transport the program for use by or in connection with the instruction execution system, apparatus or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read only memory (ROM), a rigid magnetic disk and an optical disk. Current examples of optical disks include compact disk read only memory (CD-ROM), compact disk read/write (CD-R/W), and DVD.

What is claimed is:

1. A method for remote visualization of a graphics application, comprising:
encoding operations of a first OpenGL interface for a first type of operating system as operating system independent operations;
transmitting the operating system independent operations via a network connection; and
decoding the operating system independent operations into operations of a second OpenGL interface for a second type of operating system, wherein the first and second types of operating system may be different.

2. The method as claimed in claim 1, wherein the operating system independent operations are transmitted for rendering on a remote computer system.

3. The method as claimed in claim 1, wherein the operations relate to windowing system specific rendering methods.

4. The method as claimed in claim 1, wherein the operations are initialization and management methods for associating a drawable object with rendering contexts.

5. The method as claimed in claim 1, also comprising:
transmitting drawing commands of an operating system independent form via the network.

6. The method as claimed in claim 1, wherein the operating system independent operations comprise operations for: the creation of contexts, the management of a current context, font handling, and extension handling.

7. The method as claimed in claim 1, comprising:
executing an OpenGL based graphics application on a computer system with a first type of operating system; and
intercepting operations from the graphics application for encoding.

8. The method as claimed in claim 7, comprising:
rendering the decoded operations for display on one or more remote computer systems.

9. The method as claimed in claim 8, comprising:
maintaining a map between context IDs of the graphics application and resultant context IDs on the one or more remote computer systems.

10. A system for remote visualization of a graphics application, comprising:
an encoder for encoding operations of a first OpenGL interface for a first type of operating system as operating system independent operations;
a wire protocol for transmitting the operating system independent operations via a network connection; and
a decoder for decoding the operating system independent operations into operations of a second OpenGL interface for a second type of operating system, wherein the first and second types of operating system may be different.

11. The system as claimed in claim 10, wherein the operating system independent operations are transmitted for rendering on a remote computer system.

12. The system as claimed in claim 10, wherein the operations relate to windowing system specific rendering methods.

13. The system as claimed in claim 10, wherein the operations are initialization and management methods for associating a drawable object with rendering contexts.

14. The system as claimed in claim 10, wherein:
the wire protocol also transmits drawing commands of an operating system independent form via the network.

15. The system as claimed in claim 10, wherein the operating system independent operations comprise operations for: the creation of contexts, the management of a current context, font handling, and extension handling.

16. The system as claimed in claim 10, comprising:
an OpenGL based graphics application executing on a computer system with a first type of operating system; and
means for intercepting operations from the graphics application for encoding.

17. The system as claimed in claim 16, comprising:
means for rendering the decoded operations for display on one or more remote computer systems.

18. The system as claimed in claim 17, comprising:
a map between context IDs of the graphics application and resultant context IDs on the one or more remote computer systems.

19. A system for remote visualization of a graphics application, comprising:
a local computer system with a first type of operating system;
an OpenGL based graphics application executing on the local computer system;
one or more remote computer systems for remote display of the graphics application, each with operating systems which may be of a different type from the first type of operating system; and
means for translating operating system specific OpenGL interface operations into and from operating system independent operations for transmitting between the local computer system and the one or more remote computer systems.

20. The system as claimed in claim 19, wherein the means for translating operating system specific OpenGL interface operations into and from operating system independent operations comprises:
an encoder for encoding operations of a first OpenGL interface for a first type of operating system as operating system independent operations; and
a decoder for decoding the operating system independent operations into operations of a second OpenGL interface for a second type of operating system, wherein the first and second types of operating system may be different.

21. A computer program product for remote visualization of a graphics application, the computer program product comprising:
a computer useable medium having a computer useable program code embodied therewith, the computer useable program code comprising: computer useable program code configured to perform operations, the operations comprising:
encoding operations of a first OpenGL interface for a first type of operating system as operating system independent operations;
transmitting the operating system independent operations via a network connection; and
decoding the operating system independent operations into operations of a second OpenGL interface for a second type of operating system, wherein the first and second types of operating system may be different.
